(19) United States
(12) Patent Application Publication
(10) Pub. No.: US 2008/0037940 A1
(43) Pub. Date: Feb. 14, 2008

(54) Tube for Air Blown Installation and Tube Cable Using the Same

(75) Inventor: Chan-Yong Park, Seoul (KR)

Correspondence Address: JONES DAY, 222 EAST 41ST ST, NEW YORK, NY, 10017, US

(73) Assignee: LS Cable Ltd., Gangnam-gu, Seoul (KR)

(21) Appl. No.: 11/661,769

(22) PCT Filed: Jun. 30, 2005
(86) PCT No.: PCT/KR05/02072

§ 371 Date: Sep. 20, 2007

(30) Foreign Application Priority Data
Sep. 1, 2004 (KR) 10-2004-0069648

(51) Int. Cl. G02B 6/44; F16L 11/10

(52) U.S. Cl. 385/100; 138/108; 138/137

(57) ABSTRACT

Disclosed is a tube for air blown installation and a tube cable using the same. The tube includes an outer layer made of polyethylene; and an inner layer co-extruded on an inner side of the outer layer and made of a mixture of polyethylene and siloxane, wherein the inner layer has a static coefficient of friction of 0.05 to 0.20, wherein the inner and outer layers respectively have a thickness equal to or less than 0.8 mm, and wherein no damage is caused in the tube having a length of 500 m when a pressure of 10 bars is applied thereto for 24 hours. The tube cable includes a sheath and a plurality of tube bundles. Each tube bundle is substantially identical to the above tube.

### TECHNICAL FIELD

The present invention relates to a tube for air blown installation and a tube cable using the same, and more particularly to a tube for air blown installation, which has material and structure capable of improving lubricous property and pressure resistance, and a tube cable using the same.

### BACKGROUND ART

In an optical fiber installation method using air pressure, a tube for installation is placed at a desired position and then an optical fiber unit is inserted into the tube using air pressure. This optical fiber installation method ensures easy installation and removal of an optical fiber unit and requires low construction costs, so it is widely used for installing an optical fiber in a narrow space such as FMTH (Fiber To The Home).

For the air pressure installation method, the tube for installation is generally fabricated to have double structure including a lubricous layer on its inner wall so that an optical fiber unit may be advanced easily in the tube.

FIG. 1 shows a widely used device for fabricating an installation tube having a lubricous layer as disclosed in U.S. Pat. No. 4,892,442. Referring to FIG. 1, the installation tube fabricating device includes a crosshead 12, first and second extruders 10, 11 for extruding tube material and lubricous material through the crosshead 12 respectively, and a cooling reservoir 13 for cooling an extruded object 14 with double structure having passed through the crosshead 12.

As another technique for forming a lubricous layer on the inner side of the installation tube, hotmelt may be used as shown in FIG. 2. As disclosed in U.S. Pat. No. 5,505,992, a lubricous layer 22 in a hotmelt state is formed along the inner surface of a tube 21 by using a spray device 20 to fabricate a tube for air blown installation.

The installation tubes fabricated by the above methods show different installation properties according to constitution or contents of the lubricous material since a separate lubricous layer is provided thereto. In addition, delamination, namely a phenomenon in which an outer layer and a lubricous layer are separated, or shrinkage may occur as time goes, which may deform the structure of the tube itself.

### DISCLOSURE OF INVENTION

### Technical Problem

The present invention is designed in consideration of the above problems, and therefore it is an object of the invention to provide a tube for air blown installation, which has improved lubricous properties and includes an inner lubricous layer and an outer layer in a structurally stable way, and a tube cable for air blown installation using the tube.

### Technical Solution

In order to accomplish the above object, the present invention provides a tube for air blown installation, which includes an outer layer made of polyethylene; and an inner layer co-extruded on an inner side of the outer layer and made of a mixture of polyethylene and siloxane, wherein the inner layer has a static coefficient of friction of 0.05 to 0.20, wherein the inner and outer layers respectively have a thickness equal to or less than 0.8 mm, and wherein no damage is caused in the tube having a length of 500 m when a pressure of 10 bars is applied thereto for 24 hours.

Preferably, the polyethylene is HDPE (High Density Polyethylene).

In another aspect of the invention, there is also provided a tube cable for air blown installation, which includes a sheath; and a plurality of tube bundles aggregated in the sheath, each tube bundle including an outer layer made of polyethylene and an inner layer co-extruded on an inner side of the outer layer and made of a mixture of polyethylene and siloxane, wherein the inner layer has a static coefficient of friction of 0.05 to 0.20, wherein the inner and outer layers respectively have a thickness equal to or less than 0.8 mm, and wherein no damage is caused in the tube having a length of 500 m when a pressure of 10 bars is applied thereto for 24 hours.

Preferably, the sheath is made of aluminum or its alloy.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 shows a device for fabricating a tube for air blown installation according to the prior art;

FIG. 2 is a schematic view illustrating the process of fabricating a tube for air blown installation using hotmelt according to the prior art;

FIG. 3 is a sectional view showing a tube for air blown installation according to a preferred embodiment of the present invention;

FIG. 4 is a sectional view showing a tube cable for air blown installation according to the present invention;

FIG. 5 is a photograph showing a lubricous layer separating phenomenon occurring at the tube for air blown installation according to the prior art; and

FIG. 6 is a photograph showing a lubricous layer shrinkage phenomenon occurring at the tube for air blown installation according to the prior art.

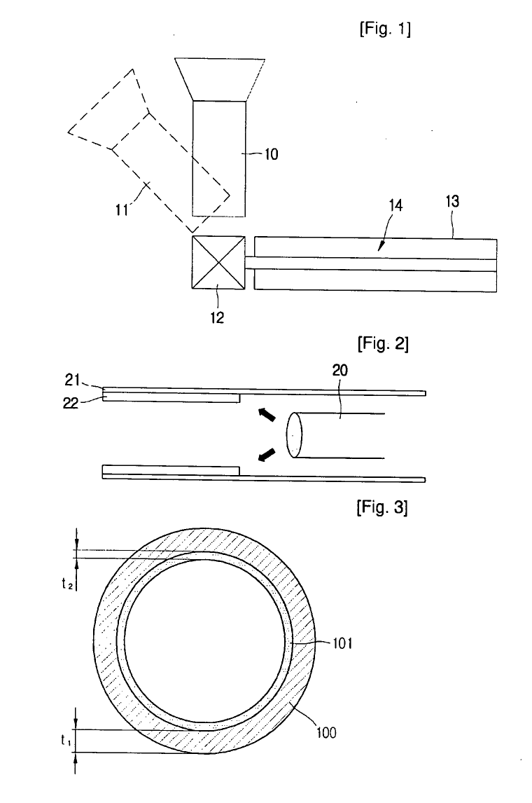

### BEST MODE FOR CARRYING OUT THE INVENTION

The present invention will be described in detail referring to the drawings. the terms used should not be construed as limited to general and dictionary meanings but based on the meanings and concepts of the invention on the basis of the principle that the inventor is allowed to define terms appropriate for the best explanation. Therefore, the description herein the scope of the invention be understood that other and modifications could be made thereto without departing from the spirit and scope of the invention.

FIG. 3 is a sectional view showing a tube for air blown installation according to a preferred embodiment of the present invention.

Referring to FIG. 3, the tube for air blown installation according to the preferred embodiment of the present invention includes an outer layer 100 made of polyethylene, and an inner layer 101 containing siloxane and formed on the inner side of the outer layer 100 by means of coextrusion.

The outer layer 100 is preferably made of HDPE (High Density Polyethylene) having excellent pressure resistance against a pressure applied during installation and relatively low in price. Generally, surface hardness is increased in proportional to density, but elongation and impact strength are decreased. In addition, impact strength, tear strength and elongation are increased in proportional to molecular weight, but melt viscosity is increased, and the properties are not increased any more over a certain threshold. Considering the above points, the HDPE preferably has a density of 0.94 to 0965 g/cm³. More preferably, HDPE having a density of 0.945 g/cm³ is used to give tensile strength of 240 kg/cm² by common ASTMD638, which may endure pressure of about 10 bars generally used during installation.

The inner layer 101 is made of a mixture of polyethylene identical to the outer layer 100 and siloxane having excellent static electricity absorption property. At this time, polyethylene is preferably HDPE identical to the outer layer 100, and siloxane is preferably UHMWSi (Ultra High Molecular Weight Siloxane) having good coefficient of friction. If siloxane master batch where UHMWSi is dispersed in HDPE is used, degree of dispersion may be improved.

The inner layer 101 gives installation properties satisfying a regulated speed when a static coefficient of friction is set to 0.05 to 0.20. This inner layer 101 may have a lubricous property satisfying the above installation properties, prevent delamination, and at the same time satisfy mechanical strength when a content of siloxane is in the range of 0.1 wt % to 5 wt % in view of characteristics of polyethylene and siloxane. As the content of siloxane is increased, the lubricous property is improved at an initial stage to lower coefficient of friction, but over the level of 5 wt % the coefficient of friction is not greatly varied but delamination is generated between the outer layer 100 and the inner layer 101 due to the increase of silicon. More preferably, the content of siloxane is in the range of 0.2 wt % to 0.3 wt %, where a static coefficient of friction has a value of about 0.10.

Thicknesses t₁ and t₂ of the outer layer 100 and the inner layer 101 are preferably designed to be equal to or lower than 0.8 mm in consideration of the pressure resistance.

The installation method using air pressure should meet the possibility for repeated uses for the purpose of re-installation. According to durability and pressure resistance for this purpose, the tube for air blown installation should have properties so that it may not be damaged when an installation pressure of about 10 bars is applied for 24 hours in a 500 m region, which is corresponding to an installation distance in a general apartment complex having 10 buildings.

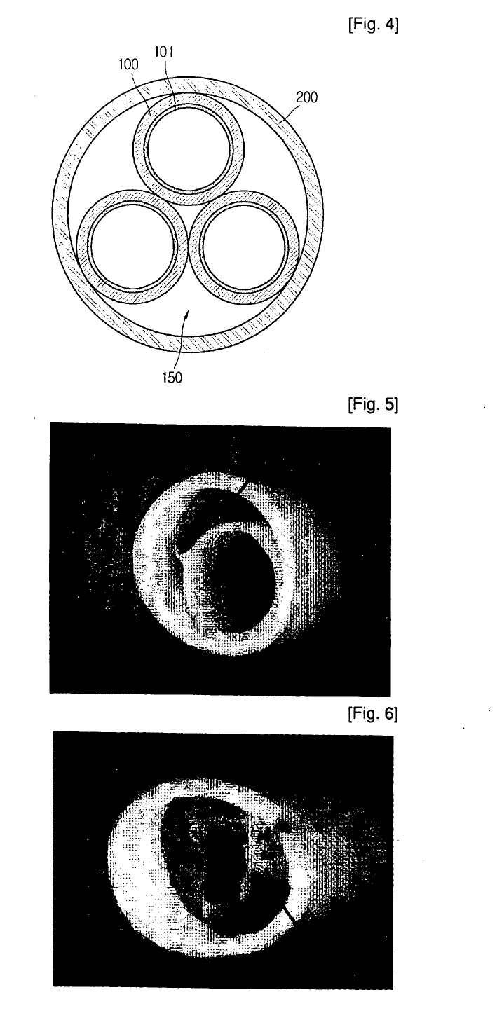

FIG. 4 shows a tube cable for air blown installation that is provided according to another aspect of the present invention.

Referring to FIG. 4, the tube cable for air blown installation includes a sheath 200 having a predetermined diameter, and tube bundles 150 aggregated in the sheath 200.

Here, each tube for air blown installation that configures the tube bundle 150 is provided with the outer layer 100 and the inner layer 101 co-extruded to the inner side of the outer layer 100 and preferably containing 0.1 wt % to 5 wt % of siloxane, identically to the above description.

The sheath 200 surrounding the tube bundles 150 is preferably made of aluminum or its alloy to prevent the tube bundles 150 from being damaged by external force and plays a role of barrier for intercepting penetration of moisture.

Mode for the Invention

### EMBODIMENT

A dedicated extruding device having double extruders was prepared to make a tube for air blown installation. HDPE was used as a material of the outer layer and supplied to a first extruder, and a compound in which 97.5% of HDPE and 2.5% of siloxane were mixed to have a coefficient of friction in the level of 0.05 to 0.06 was used as a material of the inner layer and supplied to a second extruder. Subsequently, a dice was controlled so that the outer layer had a thickness of 0.75 mm to 0.8 mm, an outer diameter of 5 mm and an inner diameter of 3.5 mm, in consideration of pressure resistance and manufacture tolerance, and then the co-extrusion process was executed.

As a result of manufacture, a double-structure tube for air blown installation in which the inner layer was uniformly formed was made, which shows good lubricous features on the inner side of the tube and does not generate delamination of the inner layer.

As for the installation characteristics, a 4-core optical fiber unit for air blown installation, generally used among the standardized ones, was used, and it was pressed in the level of 10 bars, which is a standardized allowable limit, and then tested. As a result of the test, the optical fiber unit was satisfactorily installed in a 500 m region, which is corresponding to an installation distance in a general apartment complex having 10 buildings, at a standardized rate in the level of 20 to 23 mpm without generating static electricity.

### Comparative Example 1

In order to manufacture a tube for air blown installation, a dedicated extruding device having double extruders was prepared. LDPE (Low Density Polyethylene) was used as a material of the outer layer and supplied to a first extruder, and a compound in which 92% of HDPE and 8% of siloxane were mixed to have a coefficient of friction not more than 0.05 was used as a material of the inner layer and supplied to a second extruder. Subsequently, a dice was controlled so that the outer layer had a thickness of 0.75 mm to 0.8 mm, an outer diameter of 5 mm and an inner diameter of 3.5 mm, in consideration of pressure resistance and manufacture tolerance, and then the co-extrusion process was executed.

As a result of manufacture, depression leaning to one side was generated in the lubricous layer, and the inner side of the tube and the boarder of the lubricous layer were not uniformly adhered to create a separated interface 1 as shown in FIG. 5, and the coating layer was narrowed at the center portion so that a clogged portion 2 existed.

In order to remove the clogged portion and verify the installation characteristics, a 4-core optical fiber unit for air blown installation, generally used among the standardized ones, was used, and it was pressed in the level of 10 bars, which is a standardized allowable limit, and then tested. As a result of the test, the optical fiber unit was not suitably installed due to irregularity of the inner lubricous layer, and the outer side of the tube was deformed at 10 bar, a standardized allowable limit, so the installation was stopped.

### Comparative Example 2

In order to manufacture a tube for air blown installation having a single layer, a PBT of low frictional material was prepared and supplied to a single extruder, and a dice was controlled to have an outer diameter of 5 mm and an inner diameter of 3.5 mm, and then the single layer PBT tube was manufactured.

As a result of manufacture, a tube whose inner and outer sides are smooth due to the low frictional material, PBT, and whose inner and outer sides are all uniform was extruded.

However, as a result of the installation test, executed by using a 4-core optical fiber unit for air blown installation, generally used among the standardized ones, and applying a pressure in the level of 10 bars, which is a standardized allowable limit, static electricity was generated due to friction with the wall of the tube while the optical fiber unit for air blown installation is passed, thereby causing spark. And, it was stopped after advancing about 20 m, so the installation work was impossible.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

As described above, the tube for air blown installation and the tube cable having the same according to the present invention give the following effects.

First, installation characteristics are excellent due to the optimized contents of lubricous components, and repeated use is possible due to good interfacial adherence.

Second, an installation pressure may be enhanced rather than the prior art due to excellent pressure resistance of the outer layer, so the installation efficiency may be improved.

Third, since the lubricous layer contains siloxane, static elasticity may be better prevented.

Fourth, the aluminum sheath may protect the tube for air blown installation and the optical fiber unit against mechanical or chemical stresses.

1. A tube for air blown installation, comprising:
an outer layer made of polyethylene; and
an inner layer co-extruded on an inner side of the outer layer and made of a mixture of polyethylene and siloxane,
wherein the inner layer has a static coefficient of friction of 0.05 to 0.20,
wherein the inner and outer layers respectively have a thickness equal to or less than 0.8 mm, and
wherein no damage is caused in the tube having a length of 500 m when a pressure of 10 bars is applied thereto for 24 hours.

2. The tube for air blown installation according to claim 1, wherein a content of the siloxane is 0.1 wt % to 5 wt %.

3. The tube for air blown installation according to claim 1, wherein the polyethylene is HDPE (High Density Polyethylene).

4. The tube for air blown installation according to claim 3, wherein a density of the HDPE is 0.94 to 0.965 g/cm³.

5. A tube cable for air blown installation, comprising:
a sheath; and
a plurality of tube bundles aggregated in the sheath, each tube bundle including an outer layer made of polyethylene and an inner layer co-extruded on an inner side of the outer layer and made of a mixture of polyethylene and siloxane,
wherein the inner layer has a static coefficient of friction of 0.05 to 0.20,
wherein the inner and outer layers respectively have a thickness equal to or less than 0.8 mm, and
wherein no damage is caused in the tube having a length of 500 m when a pressure of 10 bars is applied thereto for 24 hours.

6. The tube cable for air blown installation according to claim 5, wherein a content of the siloxane is 0.1 wt % to 5 wt %.

7. The tube cable for air blown installation according to claim 5, wherein the polyethylene is HDPE.

8. The tube cable for air blown installation according to claim 7, wherein a density of the HDPE is 0.94 to 0.965 g/cm³.

9. The tube cable for air blown installation according to any of claims 5 to 8, wherein the sheath is made of aluminum or its alloy.
